(19) United States
(12) Patent Application Publication
(10) Pub. No.: US 2024/0087065 A1
(43) Pub. Date: Mar. 14, 2024

(54) Methods to Provide and Market Legal Services Including Innovative Patent Prosecution Strategies

(71) Applicant: Douglas G. Metcalf, Boulder, CO (US)

(72) Inventor: Douglas G. Metcalf, Boulder, CO (US)

(21) Appl. No.: 17/943,199

(22) Filed: Sep. 13, 2022

Related U.S. Application Data
(60) Provisional application No. 63/405,862, filed on Sep. 12, 2022.

(51) Int. Cl. G06Q 50/18

(52) U.S. Cl. CPC G06Q 50/184

(57) ABSTRACT

Various aspects of this disclosure relate to methods to obtain substantive, procedural, and statistical advantages during patent prosecution and litigation.

### CROSS-REFERENCE TO RELATED APPLICATIONS

This patent application claims priority to U.S. Provisional Patent Application No. 63/405,862, filed Sep. 13, 2022, which is incorporated by reference in its entirety.

### BACKGROUND

Moderna recently filed patent litigation against Pfizer claiming over $100 billion in damages related to Pfizer's allegedly-infringing COVID vaccine. Non-practicing entities also attempt to extract tremendous value from businesses that weave together the fabric of society. Independent from the merits of any particular dispute, innovative methods to bulletproof patents for enforcement and safeguard businesses against patent threats are extremely high value.

### SUMMARY

No previous patent or patent application exists that protects innovative legal strategies for either patent prosecution or patent litigation while innumerable patents exist for business strategies in nearly every other profession. Various aspects of this disclosure relate to the identification of innovative strategies that produce substantive, procedural, and statistical advantages during patent prosecution to provide new ways for intellectual property owners to optimize cost-benefit.

This disclosure identifies substantive, procedural, and statistical advantages obtainable by filing redundant patent applications including United States nonprovisional patent applications and International Applications that are absent in patent prosecution commentary and practice.

### DETAILED DESCRIPTION

Various aspects of this disclosure relate to the strategic abandonment of patent applications. Applicants historically abandoned patent applications to avoid publication generally only in favor of trade secret protection or in favor of subsequently-filed patent families with later anticipated expiration dates. Applicants have not historically abandoned patent applications to avoid publication of unfavorable findings, for example, because unpublished findings during United States patent prosecution are nevertheless visible to United States patent examiners. This historical rationale fails, however, upon extrapolation to the global realm.

The withdrawal of an International Application to avoid publication of an unfavorable or erroneous finding in favor of a redundant International Application is helpful to foreign prosecution, for example, because many foreign patent offices rely heavily upon the work product of other patent offices including work product generated in related patent families. An additional consideration is the availability of procedures for third parties to submit analysis and conclusions to foreign patent offices, which allows various actors to indiscriminately file the unfavorable findings of international phase work product in national phase applications, for example, to suggest a consensus against patentability even when the unfavorable findings are clearly erroneous. The national phase applications of applicants from specific countries may be targeted by such third-party submissions, especially United States applicants, as well as the applications of recognizable corporations and applications related to specific subject matter such as high tech and pharmaceutical innovation.

Publication of unfavorable and erroneous findings at the international phase can create significant barriers to global patent protection that can result in tremendous time and expense to remediate. This time and expense can often be avoided by simply filing one or more redundant International Applications to allow the withdrawal of International Applications with problematic file histories to avoid their publication. The upfront cost to file a redundant International Application pales in comparison to the domestic attorney fees, translation fees, and foreign attorney fees required to overcome an unfavorable international phase finding, and such fees quickly become astronomical when comprehensive global patent protection is desired. In most instances, an unfavorable international phase finding also significantly impairs the ultimate scope of global patent protection upon which enforcement value relies.

Patent attorneys have historically purported to divine the best-suited International Search Authority to search any given International Application, and former USPTO Director David Kappos spearheaded efforts for global harmonization of patent examination, both of which suggest that variability exists between different global patent offices. Applicants can leverage this variability to create statistical advantages during global patent prosecution by filing redundant International Applications that select different International Search Authorities to examine the same subject matter. These statistical advantages become substantive advantages when the International Search Authorities arrive at different novelty or inventive step findings as they nearly always do. The statistical advantages can also become procedural advantages, for example, when international phase work product opens the door to the Patent Prosecution Highway.

Various aspects of this disclosure relate to a method of patent prosecution, comprising filing redundant patent applications, wherein each redundant patent application of the redundant patent applications discloses an inventive or non-obvious feature.

In this disclosure, the term “redundant patent applications” refers to United States utility patent applications and International Applications, and the inventive or non-obvious feature of each redundant patent application is the same for every redundant patent application of the redundant patent applications.

In this disclosure, the term “inventive” refers to a legal threshold in an International Application, wherein an inventive feature is inventive in relation to prior art.

In some embodiments, the redundant patent applications comprise a United States nonprovisional patent application.

In some embodiments, the method comprises abandoning one or more of the redundant patent applications, wherein: abandoning one or more of the redundant patent applications comprises withdrawing an International Application to result in an withdrawn International Application; the withdrawn International Application has an official file history that sets forth an unfavorable finding; the withdrawn International Application is withdrawn such that the unfavorable finding is not published under the Patent Cooperation Treaty; and a patent grants from the redundant patent applications, wherein the patent comprises a claim set that comprises a claim that includes the inventive or non-obvious feature.

In some embodiments, the patent that grants from the redundant patent applications is a United States utility patent.

The “official file history” is a record of the withdrawn International Application as held by the World Intellectual Property Organization (WIPO).

The term “published under the Patent Cooperation Treaty” refers publication under Patent Cooperation Treaty Article 21, which is identified in section 1857 of the USPTO Manual of Patent Examining Procedure, such that the official file history of the International Application becomes publicly available.

The term “withdrawing an International Application” refers to withdrawal under Patent Cooperation Treaty Article 90bis.1 such that “[n]o international publication of the international application shall be effected” under Patent Cooperation Treaty Article 90bis.1(c), which withdrawal is identified, for example, in section 1859 of the USPTO Manual of Patent Examining Procedure.

In some embodiments, the redundant patent applications comprise at least two International Applications that set forth selections of at least two different International Search Authorities; each International Application has an international filing date; each International Application has an earliest priority date for the inventive or non-obvious feature, which is either (a) a filing date of a priority patent application that discloses the inventive or non-obvious feature and to which the International Application claims priority, or which is (b) the international filing date of the International Application in the absence of any such priority patent application; each International Application lacks a priority claim to a patent application that has an earlier filing date that both (a) predates the earliest priority date for the inventive or non-obvious feature of the International Application and that (b) discloses the inventive or non-obvious feature; no earliest priority date is greater than twelve months different from any other earliest priority date; and the at least two International Applications comprise the withdrawn International Application.

In some embodiments, no earliest priority date is greater than twelve months different from any other earliest priority date such that each earliest priority date falls within the same twelve month period of Article 4 of the Paris Convention for the Protection of Intellectual Property, which is identified, for example, in Appendix P of the USPTO Manual of Patent Examining Procedure.

In some embodiments, no earliest priority date is greater than six months different from any other earliest priority date. In some specific embodiments, no earliest priority date is greater than one month different from any other earliest priority date. In some very specific embodiments, no earliest priority date is greater than one week different from any other earliest priority date.

In some embodiments, no redundant patent application that publishes under either Patent Cooperation Treaty Article 21 or Title 35 of the United States Code claims priority to any patent application to which the withdrawn International Application also claims priority. In some specific embodiments, no redundant patent application that publishes under either Patent Cooperation Treaty Article 21 or Title 35 of the United States Code claims priority to any patent application to which the withdrawn International Application also claims priority such that neither the existence of the withdrawn International Application nor the existence of any patent application to which the withdrawn International Application claims priority can be verified by searching publicly-available International Bureau records or publicly-available USPTO records with reference to a publication of a redundant patent application under the Patent Cooperation Treaty Article 21 or Title 35 of the United States Code. In some very specific embodiments, no redundant patent application that publishes under either Patent Cooperation Treaty Article 21 or Title 35 of the United States Code claims priority to any patent application to which the withdrawn International Application also claims priority such that neither the existence of the withdrawn International Application nor the existence of any patent application to which the withdrawn International Application claims priority can be verified by searching publicly-available WIPO records or publicly-available USPTO records with reference to a publication of a redundant patent application under the Patent Cooperation Treaty Article 21 or Title 35 of the United States Code.

The term “publishes under . . . Title 35 of the United States Code” refers to a publication under 35 U.S.C. § 122(b) (Title 35, section 122, subsection b of the United States Code), which is identified, for example, in section 1120 and Appendix L of the USPTO Manual of Patent Examining Procedure.

In some embodiments, the unfavorable finding is a finding that an unfavorably examined claim of the withdrawn International Application lacks an inventive step.

In some embodiments, the unfavorably examined claim includes the inventive or non-obvious feature.

In some embodiments, a redundant patent application of the redundant patent applications claims a patent prosecution method of obtaining a substantive, procedural, or statistical patent prosecution advantage during patent prosecution.

In some embodiments, a redundant patent application of the redundant patent applications claims a litigation method of obtaining a substantive, procedural, or statistical litigation advantage during litigation.

In some embodiments, the at least two International Applications comprise at least 3, 4, 5, 6, or 7 International Applications that set forth selections of at least 3, 4, 5, 6, or 7 different International Search Authorities, respectively.

In some embodiments, the at least two International Applications comprise at least three International Applications that set forth selections of at least three different International Search Authorities. In some specific embodiments, the at least two International Applications comprise at least four International Applications that set forth selections of at least four different International Search Authorities. In some specific embodiments, the at least two International Applications comprise at least five International Applications that set forth selections of at least five different International Search Authorities. In some specific embodiments, the at least two International Applications comprise at least six International Applications that set forth selections of at least six different International Search Authorities. In some very specific embodiments, the at least two International Applications comprise at least seven International Applications that set forth selections of at least seven different International Search Authorities.

The provisional patent application to which this patent document claims priority, and which is cross-referenced in the first paragraph of this disclosure, shall be used to construe this disclosure and the following claims both prior to construing either the disclosure or the following claims in light of any other reference and only if such construing is found to be reasonably necessary. In the event that any specific language of either this disclosure or the following claims is found open to reasonable interpretation in vacuo, for example, then the provisional patent application to which this patent document claims priority shall be used to construe the specific language prior to construing the specific language in light of any other reference.

1-10. (canceled)

11. A method of patent prosecution, comprising:
filing redundant patent applications that comprise three International Applications and one United States nonprovisional patent application such that (1) each of the redundant patent applications discloses an inventive or non-obvious feature; (2) the inventive or non-obvious feature is the same for each redundant patent application; and (3) each of the three International Applications sets forth a selection of a different International Search Authority;
withdrawing one of the three International Applications under Patent Cooperation Treaty Article 90bis.1 such that no international publication of the withdrawn International Application is effected under Patent Cooperation Treaty Article 90bis.1(c), wherein the withdrawn International Application has an official file history that sets forth an unfavorable finding; the unfavorable finding is a finding that an unfavorably examined claim of the withdrawn International Application lacks an inventive step; the unfavorably examined claim includes the inventive or non-obvious feature; and the method comprises withdrawing the withdrawn International Application to prevent publication of the unfavorable finding under Patent Cooperation Treaty Article 21; and
prosecuting the United States nonprovisional patent application such that a United States utility patent grants from the United States nonprovisional patent application,
wherein:
each of the three International Applications has an international filing date;
the method comprises filing the three International Applications such that each of the three International Applications has an earliest priority date for the inventive or non-obvious feature, which is either (a) a filing date of a priority patent application that discloses the inventive or non-obvious feature and to which the International Application claims priority, or which is (b) the international filing date of the International Application in the absence of any such priority patent application;
the method comprises filing the three International Applications such that each of the three International Applications lacks a priority claim to a patent application that has an earlier filing date that both (a) predates the earliest priority date for the inventive or non-obvious feature of the International Application and that (b) discloses the inventive or non-obvious feature; and
the method comprises filing each of the three International Applications such that no earliest priority date for the inventive or non-obvious feature is greater than twelve months different from any other earliest priority date for the inventive or non-obvious feature.

12. The method of claim 11, comprising filing the redundant patent applications such that no redundant patent application that publishes under either Patent Cooperation Treaty Article 21 or Title 35 of the United States Code claims priority to any patent application to which the withdrawn International Application also claims priority.

13-14. (canceled)

15. The method of claim 11, wherein a redundant patent application of the redundant patent applications claims a patent prosecution method of obtaining a substantive, procedural, or statistical patent prosecution advantage during patent prosecution.

16. The method of claim 11, wherein a redundant patent application of the redundant patent applications claims a litigation method of obtaining a substantive, procedural, or statistical litigation advantage during litigation.

17-20. (canceled)

21. The method of claim 11, comprising filing each of the three International Applications such that no earliest priority date is greater than six months different from any other earliest priority date.

22. The method of claim 11, comprising filing each of the three International Applications such that no earliest priority date is greater than one month different from any other earliest priority date.

23. The method of claim 11, comprising filing each of the three International Applications such that no earliest priority date is greater than one week different from any other earliest priority date.

24. The method of claim 11, wherein:
the method comprises filing four International Applications such that (1) each of the four International Applications discloses the inventive or non-obvious feature; (2) the inventive or non-obvious feature is the same for each of the four International Applications; and (3) each of the four International Applications sets forth a selection of a different International Search Authority;
the redundant patent applications comprise the four International Applications;
the four International Applications comprise the three International Applications;
each of the four International Applications has an international filing date;
the method comprises filing the four International Applications such that each of the four International Applications has an earliest priority date for the inventive or non-obvious feature, which is either (a) a filing date of a priority patent application that discloses the inventive or non-obvious feature and to which the International Application claims priority, or which is (b) the international filing date of the International Application in the absence of any such priority patent application;
the method comprises filing the four International Applications such that each of the four International Applications lacks a priority claim to a patent application that has an earlier filing date that both (a) predates the earliest priority date for the inventive or non-obvious feature of the International Application and that (b) discloses the inventive or non-obvious feature; and
the method comprises filing each of the four International Applications such that no earliest priority date for the inventive or non-obvious feature is greater than twelve months different from any other earliest priority date for the inventive or non-obvious feature.

25. The method of claim 24, comprising filing each of the four International Applications such that no earliest priority date is greater than six months different from any other earliest priority date.

26. The method of claim 24, comprising filing each of the four International Applications such that no earliest priority date is greater than one month different from any other earliest priority date.

27. The method of claim 24, comprising filing each of the four International Applications such that no earliest priority date is greater than one week different from any other earliest priority date.

28. The method of claim 11, wherein:
the method comprises filing five International Applications such that (1) each of the five International Applications discloses the inventive or non-obvious feature; (2) the inventive or non-obvious feature is the same for each of the five International Applications; and (3) each of the five International Applications sets forth a selection of a different International Search Authority;
the redundant patent applications comprise the five International Applications;
the five International Applications comprise the three International Applications;
each of the five International Applications has an international filing date;
the method comprises filing the five International Applications such that each of the five International Applications has an earliest priority date for the inventive or non-obvious feature, which is either (a) a filing date of a priority patent application that discloses the inventive or non-obvious feature and to which the International Application claims priority, or which is (b) the international filing date of the International Application in the absence of any such priority patent application;
the method comprises filing the five International Applications such that each of the five International Applications lacks a priority claim to a patent application that has an earlier filing date that both (a) predates the earliest priority date for the inventive or non-obvious feature of the International Application and that (b) discloses the inventive or non-obvious feature; and
the method comprises filing each of the five International Applications such that no earliest priority date for the inventive or non-obvious feature is greater than twelve months different from any other earliest priority date for the inventive or non-obvious feature.

29. The method of claim 28, comprising filing each of the five International Applications such that no earliest priority date is greater than six months different from any other earliest priority date.

30. The method of claim 28, comprising filing each of the five International Applications such that no earliest priority date is greater than one month different from any other earliest priority date.

31. The method of claim 28, comprising filing each of the five International Applications such that no earliest priority date is greater than one week different from any other earliest priority date.

32. The method of claim 11, wherein:
the method comprises filing six International Applications such that (1) each of the six International Applications discloses the inventive or non-obvious feature; (2) the inventive or non-obvious feature is the same for each of the six International Applications; and (3) each of the six International Applications sets forth a selection of a different International Search Authority;
the redundant patent applications comprise the six International Applications;
the six International Applications comprise the three International Applications;
each of the six International Applications has an international filing date;
the method comprises filing the six International Applications such that each of the six International Applications has an earliest priority date for the inventive or non-obvious feature, which is either (a) a filing date of a priority patent application that discloses the inventive or non-obvious feature and to which the International Application claims priority, or which is (b) the international filing date of the International Application in the absence of any such priority patent application;
the method comprises filing the six International Applications such that each of the six International Applications lacks a priority claim to a patent application that has an earlier filing date that both (a) predates the earliest priority date for the inventive or non-obvious feature of the International Application and that (b) discloses the inventive or non-obvious feature; and
the method comprises filing each of the six International Applications such that no earliest priority date for the inventive or non-obvious feature is greater than twelve months different from any other earliest priority date for the inventive or non-obvious feature.

33. The method of claim 32, comprising filing each of the six International Applications such that no earliest priority date is greater than six months different from any other earliest priority date.

34. The method of claim 32, comprising filing each of the six International Applications such that no earliest priority date is greater than one month different from any other earliest priority date.

35. The method of claim 32, comprising filing each of the six International Applications such that no earliest priority date is greater than one week different from any other earliest priority date.

36. The method of claim 11, wherein:
the method comprises filing seven International Applications such that (1) each of the seven International Applications discloses the inventive or non-obvious feature; (2) the inventive or non-obvious feature is the same for each of the seven International Applications; and (3) each of the seven International Applications sets forth a selection of a different International Search Authority;
the redundant patent applications comprise the seven International Applications;
the seven International Applications comprise the three International Applications;
each of the seven International Applications has an international filing date;
the method comprises filing the seven International Applications such that each of the seven International Applications has an earliest priority date for the inventive or non-obvious feature, which is either (a) a filing date of a priority patent application that discloses the inventive or non-obvious feature and to which the International Application claims priority, or which is (b) the international filing date of the International Application in the absence of any such priority patent application;
the method comprises filing the seven International Applications such that each of the seven International Applications lacks a priority claim to a patent application that has an earlier filing date that both (a) predates the earliest priority date for the inventive or non-obvious feature of the International Application and that (b) discloses the inventive or non-obvious feature; and
the method comprises filing each of the seven International Applications such that no earliest priority date for the inventive or non-obvious feature is greater than twelve months different from any other earliest priority date for the inventive or non-obvious feature.
